(19) United States
(12) Patent Application Publication
(10) Pub. No.: US 2006/0281046 A1
(43) Pub. Date: Dec. 14, 2006

(54) Stent for guiding the location/direction of implant, and production method thereof

(75) Inventor: Jun-Seok Heo, Banghak-dong (KR)

Correspondence Address: CLARK & ELBING LLP, 101 FEDERAL STREET, BOSTON, MA, 02110, US

(73) Assignee: MJRAD Co., LTD., Seoul (KR)

(21) Appl. No.: 10/555,323

(22) PCT Filed: Sep. 3, 2004
(86) PCT No.: PCT/KR04/02242

§ 371 Date: Nov. 2, 2005

(30) Foreign Application Priority Data
Sep. 4, 2003 (KR) 1020030061939
Jul. 30, 2004 (KR) 1020040060621

(51) Int. Cl. A61C 3/00

(52) U.S. Cl. 433/75

(57) ABSTRACT

The present invention is disclosed a stent for guiding the location/direction for the insertion of an implant a production method thereof. The method includes the steps of forming a plaster cast modeling of a mouth state using a plastic replica; and manufacturing a plastic cast model having an occlusal surface of the location for the insertion of the implant using the plaster cast; fastening a plastic plate having on corners thereof a plurality of metal balls to an upper end of the plastic cast model; and obtaining computed tomographic (CT) image of the mouth after placing the plastic cast model, on which the plastic plate is fastened, in the mouth, and forming a hole in a predetermined position in the stent to correspond to both a location and a direction of inserting the implant determined by a dentist based on the CT image.

### TECHNICAL FIELD

The present invention relates, in general, to devices for guiding the installation of implants and production methods thereof and, more particularly, to a guide model used for the insertion of an implant and a method of producing a stent for guiding the location and direction for the insertion of an implant as determined by a dentist.

### BACKGROUND ART

Generally, in a dental implant operation to fill a region of a mouth where a patient is missing a tooth, it is important to insert that the implant is installed at a stable and precise location and angle and to a precise depth. If damage to the root of an adjacent tooth occurs due to an implant being inserted in a wrong location, the damaged adjacent tooth must be undesirably removed. In particular, the insertion of the implant must avoid anatomic structures, such as nervous tissue of a lower jaw and a maxillary sinus of an upper jaw or a lower jaw Therefore, before the dental implant operation is executed, a determination of the location of safety for precisely inserting of the implant must be conducted. As well, to minimize the above-mentioned dangers, in the dental implant operation, a guide model for guiding the precise and stable location and direction for insertion of the implant has been used.

The guide model is called a stent. The stent means a plastic cast model capable of being fitted in the mouth of the patient. A method of producing a conventional stent for the implant and usage of the same are as follows:

1) The stent is produced to confirm a position suitable for insertion of an implant. The stent is produced using plastic material suitable and reproducible for a patient's tooth and gingiva, and it have the positioning material capable of the position such as metal ball, metal rod, filling material for endodontic treatment, and vacant area on computed tomographic image.

2) In the state in which the produced stent is mounted in the mouth of the patient, the CT images of the mouth (jaw including the stent, the position of missing tooth) are obtained. A positional relationship between the indicating material and a jawbone is calculated using the obtained CT images. Thereafter, a guide hole is formed on the stent at the desired position and angle. The implant is installed in the jawbone through the guide hole of the stent.

However, in the above-mentioned dental implant operation, a dentist confirms the positional relationship between the indicating material and the jawbone observed in the CT images with the naked eye prior to forming the guide hole on the stent at the desired and revaluated position. As such, the manufacture of the stent and the use of the same depend only on the experience and senses of the dentist. Therefore, there is a probability of error occurring. As well, in the substantial implant operation, errors may also occur.

Background and conventional arts were disclosed in U.S. Pat. Nos. 5,927,982, 5,015,183, 5,133,660 and 5,967,777, and in Japan Laid-open Publication No. Heisei. 2003-88537.

A principle of each of the conventional arts disclosed in Japan Laid-open Publication No. Heisei. 2003-88537 and U.S. Pat. No. 5,927,982 is as follows. First, CT images of a jawbone including teeth are obtained. A three-dimensional image is obtained and, thereafter, a three-dimensional plastic rapid prototyping (RP) model modeling the jawbone is manufactured using data of the three-dimensional image. After the location of inserting the implant is determined based on the CT images, a guide hole is formed on the three-dimensional plastic rapid prototyping model according to the determined direction and angle.

However, in a process of manufacturing the plastic rapid prototyping model by reconstructing the CT images, the thickness for forming a section of the plastic rapid prototyping model is irregular (for example, the thickness ranges from 0.5 mm to 1 mm). Thus, the accuracy of the manufactured plastic rapid prototyping model is reduced and, thereby the dental implant operation is unstable. Furthermore, to manufacture the plastic rapid prototyping model, a method in which powder is finely piled is used. In this process, an error in determining the insertion direction of the implant may occur. In addition, because the process of manufacturing the plastic rapid prototyping model is very complicated and requires special materials and expensive equipment, production costs are excessively increased.

### DISCLOSURE

### Technical Problem

Accordingly, to solve the above problems occurring in the prior art, and an object of the present invention is to provide a stent which is capable of guiding the insertion of an implant as determined by a dentist, and a method of producing the same.

Another object of the present invention is to provide a stent and a method of producing the same which is simple and inexpensive.

### DESCRIPTION OF DRAWINGS

FIG. 1 is a flow chart showing a method of producing a stent, according to an embodiment of the present invention;

FIG. 2 is a view showing an example of a mouth model;

FIG. 3 is a view showing a plastic plate of the present invention;

FIG. 4 is a sectional view showing a state in which the plastic plate of FIG. 3 is fastened on a model of a region where a tooth is missing;

FIG. 5 is a view showing a CT image in which the stent of the present invention is displayed;

FIG. 6 is a view showing a CT image of metal balls of the plastic plate shown in the CT image of FIG. 5;

FIG. 7 is a flow chart showing a process of manufacturing the stent for guiding the location/direction of an implant using the plastic plate of FIG. 3;

FIG. 8 is a flow chart showing a determination of the location of inserting the implant in consideration of a spatial positional relationship between the metal balls described in FIG. 7; and

FIG. 9 is a view to visually show a positional relationship between the metal balls and the insertion location of the implant described in FIG. 8.

### BEST MODE

In an aspect, the present invention provides a method of producing a stent for guiding the location/direction for the insertion of an implant, including the steps of: forming a plaster cast modeling of a mouth state using a plastic replica; manufacturing a plastic cast model by conventional dental material for stent such as resin having an occlusal surface of the location for the insertion of the implant using the plaster cast; fastening a plastic plate having on corners thereof a plurality of metal balls to an upper end of the stent; and obtaining a computed tomographic (CT) image of the mouth after placing the plastic cast model (stent), on which the plastic plate is fastened, in the mouth, and forming a hole on a predetermined position in the stent to correspond to both a location and a direction for the insertion of the implant determined by a dentist based on the CT image.

The determination of the location and direction (angle) for the insertion of the implant may depend on a spatial positional relationship between the metal balls displayed in the CT image.

The metal balls may comprise at least three metal balls.

Also, the method of producing the stent for guiding the location/direction for the insertion of the implant may further include a step of forming an implant guide hole on the plastic cast model (stent), on which the plastic plate is fastened, according to the predetermined, location and direction.

The determination of the location and direction for the insertion of the implant may include the steps of determining positions of the metal balls from the obtained CT image; defining a plane provided by the metal balls using the positions of the metal balls respectively; and calculating a relationship between the defined plane and an imaginary implant.

In another aspect, the present invention provides a stent for guiding the location/direction for the insertion of an implant, comprising: a plastic cast model having an occlusal surface of a predetermined portion into which the implant is inserted; a plastic plate having at least three metal balls and attached to the plastic cast model to be parallel with each other; and an implant guide hole formed on a predetermined position of the plastic cast model corresponding to a hole determined according to a predetermined algorithm.

The predetermined algorithm may include the steps of determining positions of the metal balls from an obtained computed tomographic (CT) image; defining a plane provided by the metal balls using the positions of the metal balls respectively; and calculating a relationship between the defined plane and an imaginary implant.

A further aspect, the present invention provides a method of determining a position of a guide hole of a stent for guiding the location/direction for the insertion of an implant, including the steps of: obtaining a computed tomographic (CT) image of a mouth after placing the stent in the mouth; determining positions of the metal balls from the obtained CT image; defining a plane provided by the metal balls using the positions of the metal balls respectively; and calculating a relationship between the defined plane and an imaginary implant.

The determination of the positions of the metal balls may include the steps of giving a number to each of the metal balls; defining a line, connecting metal ball number one to metal ball number two, as an X-axis, and defining another line, connecting metal ball number one to metal ball number three, as a Y-axis; confirming whether an angle between the two lines is perpendicular, and determining the determination of the positions of the metal balls to be in error if the angle between the two lines is not perpendicular, and defining a Z-axis by finding a vector product of the X-axis and the Y-axis if the angle between the two lines is the right angle, and measuring an insertion depth of the implant (I) based on the plane defined by the metal balls; and finding an intersection point (P) between an extension line of the implant (I) and a plane (S) formed by the X-axis and the Y-axis.

### MODE FOR INVENTION

A principle of the present invention is that a mouth model having the same shape as a patient's mouth structure is provided by using a dental plastic replica, thus reducing production costs, and preventing an error from occurring during a dental implant operation. Furthermore, the present invention is provided the precise location and direction of a guide hole by using a plastic plate including three or four metal balls. In an explanation of the metal balls, the number of the metal balls will be described as three or more, three or four, or four. That is, the plastic plate includes at least three metal balls.

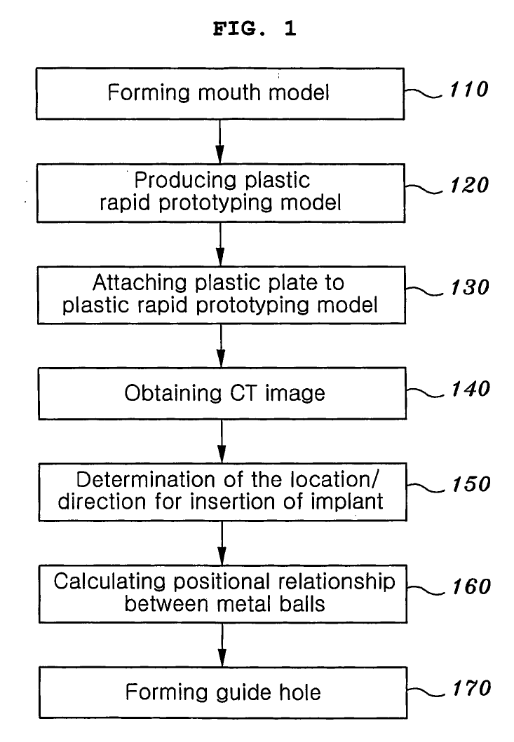

FIG. 1 is a flow chart showing a method of producing a stent, according to an embodiment of the present invention.

Hereafter, the present invention will be explained with reference to FIG. 1.

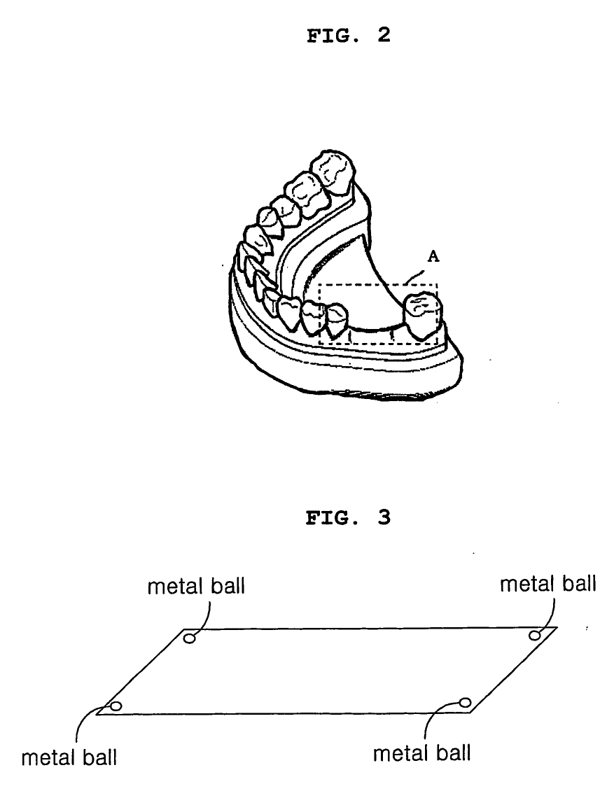

At step 110, a mouth model is formed. The mouth model is made of a dental plastic replica. A plaster cast modeling the mouth including a region for an implant insertion is formed. An example of the plaster cast is shown in FIG. 2.

At step 120, an engraved plastic cast model or conventional stent without indicating material having an occlusal surface of the region (A) of inserting the implant is manufactured on the plaster cast. Here, because a shape of the mouth of the patient is reproduced without error, the plastic cast model can be in precisely close contact with the teeth of the patient.

At step 130, a plastic plate is placed on the plastic cast model to be parallel to a horizontal axis of the plastic cast model. Thereafter, the plastic plate is firmly fastened to the plastic cast model by a resin material. At this time, the plastic plate has very small metal balls (preferably, about 1 mm diameter balls) on corners thereof. The size of the metal balls may be standardized.

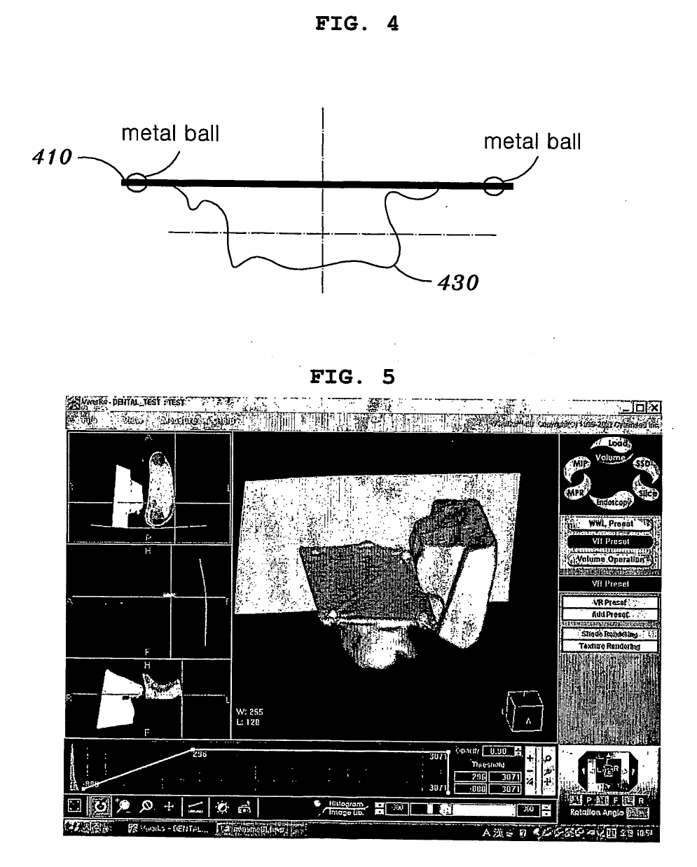

An example of the plastic plate having the metal balls is shown in FIG. 3. FIG. 4 is a side view of the plastic cast model on which the plastic plate having the metal balls is fastened. In FIG. 4, the reference numeral 410 is plastic plate and the reference numeral 430 is the plastic cast model having the occlusal surface of the location (A) of inserting the implant.

At step 140, the plastic cast model, on which the plastic plate is fastened, is placed in the mouth. Thereafter, a computed tomographic (CT) image of the mouth is obtained. As such, the obtained CT image is shown in FIG. 5. Here, to display the CT image, the well-known three-dimensional digital medical image information processing system is used.

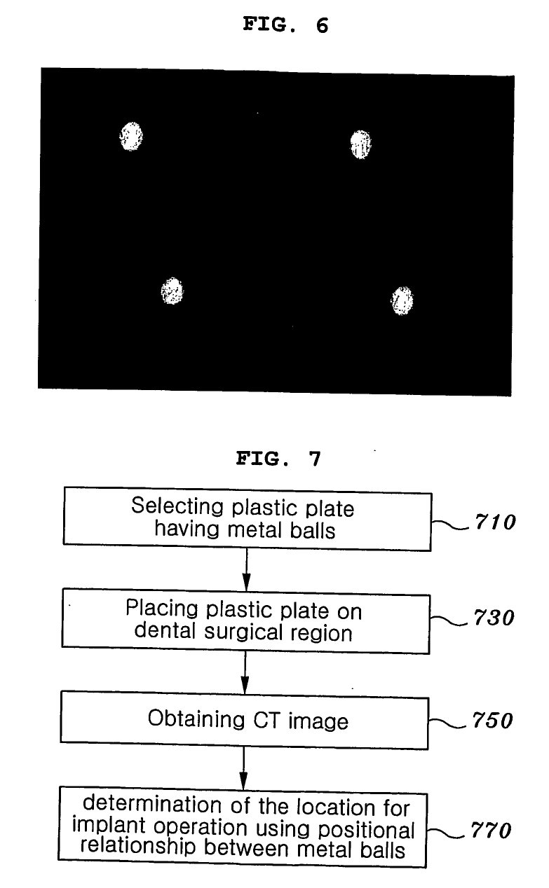

At step 150, a dentist determines a location and a direction of inserting the implant by using the CT image. Thereafter, as step 160, a spatial positional relationship between the four metal balls and an axis in the insertion direction of the implant determined by the dentist is calculated. In detail, information about an intersection point and angle between an extension line of the insertion axis of the implant determined from the CT image and a plane formed by connecting centers of three or four metal balls is obtained. At this time, the metal balls are used as a means to express a direction for the insertion of the implant as numerical values and to form a hole on the stent using the confirmed numerical values. As such, when the plastic plate having the three or four metal balls on the corner is used, only metal balls are displayed on the CT image as shown in FIG. 6. By using this CT image, the spatial and positional relationship between the metal balls and the location and the direction for insertion of the implant determined by the dentist can be easily and precisely calculated.

A standardization method of the three or four metal balls used in the present invention becomes a basis of various dental operations to be executed in the mouth. This technique may be used in various fields as well as the present invention.

Finally, as step 170, the hole is formed using a drill on a predetermined position in the stent to correspond to both the location and the direction for insertion of the implant calculated in step 160.

As described above, the plastic plate having the three or four metal balls is useful in the automation of dental operations to be executed in the mouth. In other words, when the plastic plate having the metal balls is used, it is possible to conveniently and precisely obtain various data. Furthermore, the plastic plate having the metal balls serves as a fiducial point for a dental surgical operation. For example, numerical values are obtained from the metal balls and the obtained numerical values are calculated using a robot. The calculated numerical values can be used as spatial indicators in the case of a dental treatment or surgical operation. A method of producing the stent for precisely guiding the location/direction for the insertion of the implant for a dental surgical operation in the mouse using the plastic plate according to the present invention is shown in FIG. 7.

Referring to FIG. 7, at step 710 a size of the plastic plate suitable for a dental surgical region in a patient's mouth is determined. At step 730, the plastic plate of the determined predetermined size, which has at least three metal balls on corners thereof, is placed on the dental surgical region in the patient's mouth. At step 750, a computed tomographic (CT) image of the mouth, in which the plastic plate is placed, is obtained. At step 770, a guide hole is formed using a spatial positional relationship between the metal balls confirmed from the CT image. At step 730, the plastic plate is used as a spatial indicator. Therefore, preferably, an assistant model, such as the plastic cast model 430, is placed along with the plastic plate on the dental surgical region.

There is the following difference between the implant guide stent of the present invention and a conventional technique disclosed in U.S. Pat. No. 5,967,777. In claim 1 of the US Patent, the use of a radiopaque fiducial marker is proposed. However, the radiopaque fiducial marker is directly attached to a plastic replica after a position to be attached to a plane is computed, as shown in FIG. 5 of U.S. Pat. No. 5,967,777. In comparison with this, in the present invention, the metal balls are previously placed on the planar plastic plate as shown in FIG. 3, and thereafter, the plastic plate having the metal balls is attached to the dental plastic replica. In addition, the present invention does not require the process shown in FIG. 5 of U.S. Pat. No. 5,967,777. Furthermore, in U.S. Pat. No. 5,967,777, a separate pin must be tightened into a lower part of the radiopaque fiducial marker to fasten the radiopaque fiducial marker to a predetermined position during a drilling process, as shown in FIG. 10. In other words, it is necessary that a separate device be mounted on an existing CNC milling machine. However, in the implant guide stent of the present invention, because the planar plastic plate is used, the stent is easily fastened in the CNC milling machine. Therefore, the guide hole can be simply formed on the stent without a separate fastening device.

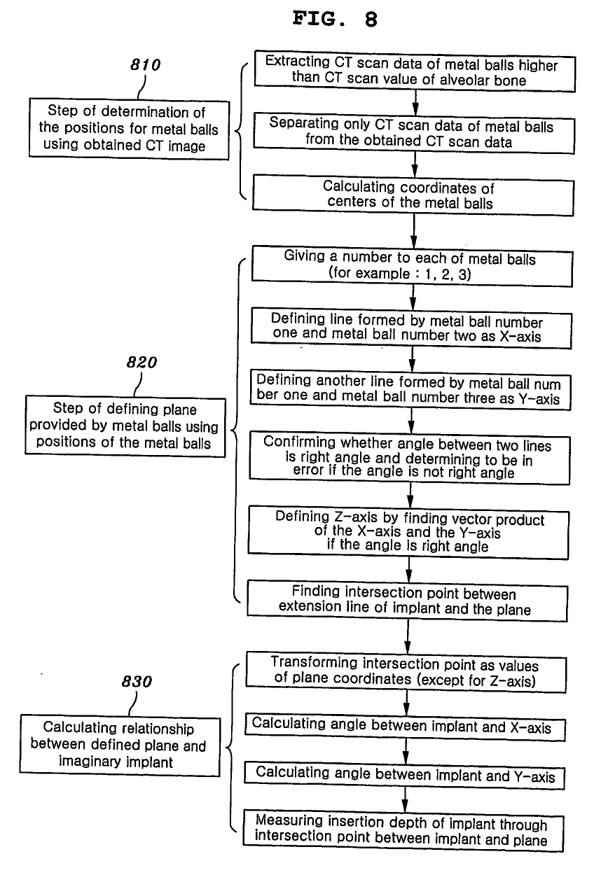

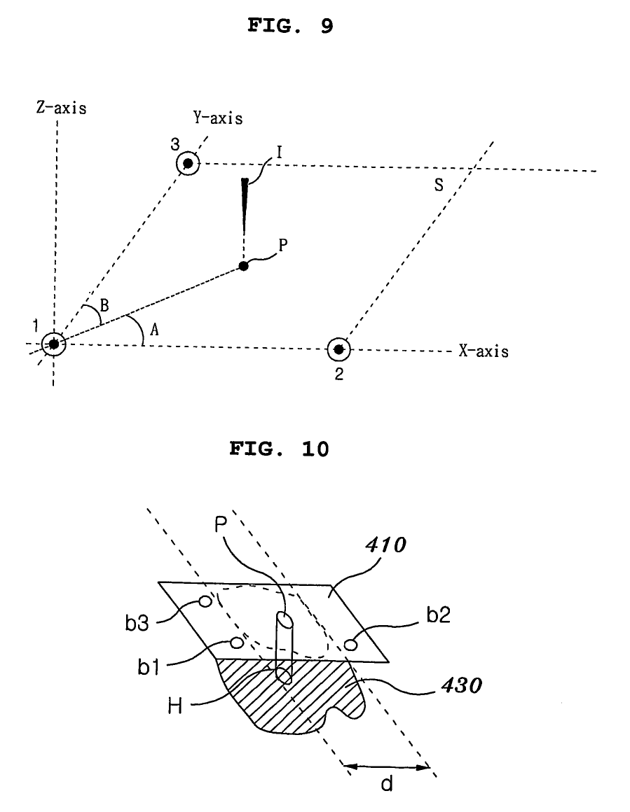

FIG. 8 is a flow chart showing a determination of the insertion location for the insertion of the implant in consideration of the spatial positional relationship between the metal balls described in FIG. 7. FIG. 9 is a view to visually show the method of determining the insertion location of the implant. Here, the insertion location of the implant means a position of the guide hole formed on the implant guide stent including the plastic plate.

Referring to FIG. 8, at step 810, positions of the metal balls from the obtained CT image are determined. At step 820, a plane provided by the metal balls using the positions of the metal balls is defined. At step 830, a relationship between the defined plane and an imaginary implant is calculated.

The step 810 includes a process of extracting CT scan data higher than CT scan values of alveolar bone around the metal balls, a process of separating only the CT scan data of metal balls from the obtained CT scan data, and a process of calculating the coordinates of centers of the metal balls. At this time, the CT scan values of the metal balls are higher than those of normal anatomic structures. On the basic of this, the separation of the data means that all structures except for the metal balls are expressed in black, when data having value higher than a predetermined CT scan value is extracted.

The step 820 includes a process of giving a number (for example number one, number two and number three) to each of the metal balls, and a process of defining a line, connecting metal ball number one to metal ball number two, as an X-axis, and defining another line, connecting metal ball number one to metal ball number three, as a Y-axis. The step 820 further includes a process of confirming whether an angle between the two lines is a right angle, and a process of determining the positions of the metal balls to be in error if the angle between the two lines is not the right angle, and defining a Z-axis by finding a vector product of the X-axis and the Y-axis if the angle between the two lines is the right angle. The step 820 further includes a process of finding an intersection point (P) between an extension line of the implant (I) and a plane (S) formed by the X-axis and the Y-axis.

The step 830 includes a process of transforming the intersection point (P) as values of plane coordinates (except for the Z-axis), a process of calculating an angle (A) between the implant (I) and the X-axis; and a process of calculating an angle (B) between the implant (I) and the Y-axis, and a process (C) of measuring an insertion depth of the implant (I) in consideration of the length of the implant (I) based on the plane defined by the metal balls.

Using the above-mentioned processes, the present invention simply and precisely obtains the location (P) for insertion of the implant using the coordinates calculation.

A stent for guiding the location/direction for the insertion of an implant produced through the above-mentioned stent production method is shown in FIG. 10. Referring to FIG. 10, the implant guide stent includes a plastic cast model 430 having an occlusal surface of a predetermined portion into which the implant is inserted, a plastic plate 410 which has at least three metal balls b1, b2 and b3 and is attached to the plastic cast model to be parallel with it, and an implant guide hole (H) which is formed in a predetermined position (P) of the plastic cast model corresponding to a hole determined according to a predetermined algorithm, that is, the steps described in FIG. 8.

In the implant guide stent of FIG. 10, a distance ‘d’ between the metal ball b1 and the metal ball b2 is preferably the same as the width of a junction surface between the plastic cast model 430 and the plastic plate 410.

Although the preferred embodiment of the present invention has been disclosed for illustrative purposes, those skilled in the art will appreciate that various modifications, additions and substitutions are possible, without departing from the scope and spirit of the invention as disclosed in the accompanying claims. For example, an implant guide stent, which is produced according to the conventional technique, and on which the plastic plate having the metal balls according to the present invention is placed, can be regarded as falling within the scope of the present invention. As well, the calculation of the location of the implant using a computed is very important factor in the manufacture and application of the implant guide stent of the present invention. Therefore, elements that relate to a method of determining the position and the direction of the guide hole formed in the implant guide stent using predetermined software or other methods can also be regarded as falling within the scope of the present invention.

As such, the scope of the present invention is not confined to the disclosed preferred embodiment, but must be decided within the bounds of the accompanying claims of the present invention, or within elements to be embraced by the claims.

### INDUSTRIAL APPLICABILITY

A described above, the present invention uses a natural model modeling a mouth state of a patient, so that a precise and stable stent can be produced. Furthermore, because a guide hole is formed in the stent in a desired direction by a dentist, an implant insertion operation reflecting the opinion of the dentist can be executed.

In addition, the present invention does not require expensive materials or devices, thus simplifying production, and reducing production costs. As well, in the present invention, a CT image is obtained using a plastic plate having three or four metal balls, and the location and direction for insertion of the implant are determined using the obtained CT image. Thus, the implant can be inserted at the precise location and angle. Moreover, the present invention obtains the CT image using the plastic plate having three or four metal balls, and the guide hole is formed in a predetermined position of the stent to correspond to both a location and a direction for insertion of the implant determined by the dentist based on the obtained CT image. Accordingly, the dentist can insert the implant at a precise location and in a precise direction.

1. A method of producing a stent for guiding the location/direction for the insertion of an implant, comprising the steps of:
forming a plaster cast modeling of a mouth state using a plastic replica;
manufacturing a plastic cast model having an occlusal surface of the location for the insertion of the implant using the plaster cast;
fastening a plastic plate having on corners thereof a plurality of metal balls to an upper end of the plastic cast model; and
obtaining a computed tomographic (CT) image of the mouth after placing the plastic cast model, on which the plastic plate is fastened, in the mouth, and forming a hole on a predetermined position in the stent to correspond to both a location and a direction for the insertion of the implant determined by a dentist based on the CT image.

2. The method of producing the stent for guiding the location/direction for the insertion of the implant according to claim 1, wherein the determination of the location and direction for the insertion of the implant depends on a spatial positional relationship between the metal balls displayed in the CT image.

3. The method of producing the stent for guiding the location/direction for the insertion of the implant according to claim 1, wherein the metal balls comprise at least three metal balls.

4. The method of producing the stent for guiding the location/direction for the insertion of the implant according to claim 1, further comprising a step of:
forming an implant guide hole on the plastic cast model, on which the plastic plate is fastened, according to the predetermined location and direction.

5. The method of producing the stent for guiding the location/direction for the insertion of the implant according to claim 2, wherein the determination of the location and direction for insertion of the implant comprises the steps of:
determining positions of the metal balls from the obtained CT image;
defining a plane provided by the metal balls using the positions of the metal balls respectively; and
calculating a relationship between the defined plane and an imaginary implant.

6. A stent for guiding the location/direction for the insertion of an implant produced by the method according to any one of claims 1 through 5.

7. A stent for guiding the location/direction for the insertion of an implant, comprising:
a plastic cast model 430 having an occlusal surface of a predetermined portion into which the implant is inserted;
a plastic plate 410 having at least three metal balls (b1,b2,b3) and attached to the plastic cast model to be parallel with each other; and
an implant guide hole (H) formed on a predetermined position (P) of the plastic cast model corresponding to a hole determined according to a predetermined algorithm.

8. The stent for guiding the location/direction for the insertion of the implant according to claim 7, wherein the predetermined algorithm comprises the steps of:
determining positions of the metal balls from an obtained computed tomographic (CT) image;
defining a plane provided by the metal balls using the positions of the metal balls respectively; and
calculating a relationship between the defined plane and an imaginary implant.

9. A method of determining a position of a guide hole of a stent for guiding the location/direction for the insertion of an implant, the stent having a plastic cast model 430 having an occlusal surface of a predetermined portion into which the implant is inserted; and a plastic plate 410 having at least three metal balls (b1,b2,b3) and attached to the plastic cast model to be parallel to each other, the method comprising the steps of:
obtaining a computed tomographic (CT) image of a mouth after placing the stent in the mouth;
determining positions of the metal balls from the obtained CT image;
defining a plane provided by the metal balls using the positions of the metal balls respectively; and
calculating a relationship between the defined plane and an imaginary implant.

10. The method of determining the position of the guide hole of the stent for guiding the location/direction for the insertion of the implant according to claim 9, wherein the determination of the positions of the metal balls comprises the steps of:
giving a number to each of the metal balls;
defining a line, connecting metal ball number one to metal ball number two, as an X-axis, and defining another line, connecting metal ball number one to metal ball number three, as a Y-axis;
confirming whether an angle between the two lines is perpendicular, and determining the positions of the metal balls to be in error if the angle between the two lines is not perpendicular, and defining a Z-axis by finding a vector product of the X-axis and the Y-axis if the angle between the two lines is perpendicular; and measuring an insertion depth of the implant (I) based on the plane defined by the metal balls; and
finding an intersection point (P) between an extension line of the implant (I) and a plane (S) formed by the X-axis and the Y-axis.
